(19) United States
(12) Patent Application Publication
(10) Pub. No.: US 2020/0139456 A1
(43) Pub. Date: May 7, 2020

(54) HOLE CUTTER

(71) Applicant: TnC SHARK CO., LTD, Paju-si (KR)

(72) Inventor: Sung Kang JO, Seoul (KR)

(73) Assignee: TnC SHARK CO., LTD, Paju-si (KR)

(21) Appl. No.: 16/230,345

(22) Filed: Dec. 21, 2018

(30) Foreign Application Priority Data
Nov. 5, 2018 (KR) 10-2018-0134511

(51) Int. Cl. B23B 51/04

(52) U.S. Cl. CPC B23B 51/046; B23B 51/08; B23B 51/0473

(57) ABSTRACT

Disclosed is a hole cutter including a unit cutting edge, the unit cutting edge including a front surface portion, an inside surface portion, an outside surface portion, and a rear surface portion. The front surface portion includes a first machined surface; and a second machined surface which has a structure which is formed with a surface distinguished from the first machined surface with respect to a first boundary line and is connected to the first machined surface along the first boundary line. The rear surface portion includes a third machined surface; and a fourth machined surface which has a structure which is formed with a surface distinguished from the third machined surface with respect to a second boundary line and is connected to the third machined surface along the second boundary line.

### CROSS-REFERENCE TO RELATED APPLICATIONS

This application claims the benefit of Korean Application No. 10-2018-0134511, filed Nov. 5, 2018, in the Korean Intellectual Property Office. All disclosures of the document named above are incorporated herein by reference.

### FIELD

The present invention relates to a hole cutter, and more particularly, to a hole cutter which is capable of inducing the smooth external discharge of a cutting chip generated during a hole machining process and reducing a cutting load applied to a cutting edge.

### BACKGROUND

Generally, a hole cutter is a tool which is helpfully used for forming a hole having a predetermined diameter or more in a plate material of various materials such as a thin steel plate or a wooden door, and is used in a state of being mounted on a drilling machine which provides a rotation force like a drill gun.

The hole cutter can be classified into a high-speed-steel hole cutter and a carbide-tipped hole cutter according to the shape of a cutting body. The high-speed-steel hole cutter refers to a hole cutter which has a serrated cutting edge and the carbide-tipped hole cutter refers to a hole cutter which has a plurality of cutting edges and a cutting tip coupled to one end portion of an oblique rim of the cutting edge.

Such a hole cutter is mounted on a drilling machine such as a drill gun and can machine a hole having a predetermined diameter on a plate material such as wood or a steel plate by rotating the cutting edge.

In the various types of hole cutters described above, the high-speed-steel hole cutter will be described in more detail as follows. In the related art, the high-speed-steel hole cutter includes a cylindrical hollow container, a plurality of cutting edges which are formed around one end portion of the hollow container, a drill holder which is formed as a shank to be coupled to a drill chuck, and a drill bit which is fitted and fixed to the center of the other end portion of the drill holder.

In the related art, particularly, the cutting edge of the high-speed-steel hole cutter is serrated and is disposed at regular intervals along an edge of one end portion of the hollow container. However, in the related art, the high-speed-steel hole cutter has the following problems due to such a serrated cutting edge structure.

(1) Frequently, cutting chips generated during hole machining are caught in the grooves (that is, grooves between teeth) of the cutting edge, or are not smoothly discharged from the hollow container of the hole cutter to the outside and remain there. When the cutting chip is caught in the groove or is not discharged to the outside, described above, the cutting edge cannot dig a workpiece, and slips or stops rotation thereof. Therefore, the operator has to remove the cutting chips individually during the hole machining. However, there is a problem that it is time-consuming to remove the cutting chips strongly adhered to the cutting body by using a drill or the like, which causes the working efficiency to be lowered.

(2) In a case where the cutting edge abruptly touches the plate material, and in a case where the load is continuously applied to the cutting edge, there is a problem that the cutting edge may become stuck in the plate material, causing the cutting edge to be missed or broken and the hole cutter to be broken, or rotation of the hole cutter to stop.

(3) When machining hole in a plate material, the center hole drilled by the drill bit is widened, causing the cutting body to be shaken. As a result, the contact state of the cutting edge to the plate material becomes unstable. In this case, there is a problem that the hole is not precisely machined, the hole is drilled larger than the standard size, the machined surface of the workpiece is not clean, and the cutting edge is damaged.

### SUMMARY

The present invention has been made to solve the problems described above, an objective of the present invention is to provide a hole cutter which is capable of inducing smooth external discharge of cutting chips generated during a hole machining process, reducing a cutting load applied to a cutting edge, and minimizing the shaking of a cutting body generated during a hole machining process.

According to the present invention, so as to achieve the above object, there is provided a hole cutter including: a cylindrical body; and a plurality of unit cutting edges disposed along an edge of the body.

The unit cutting edge includes a front surface portion, an inside surface portion, an outside surface portion, and a rear surface portion.

The front surface portion includes: a first machined surface; and a second machined surface which has a structure which is formed with a surface distinguished from the first machined surface with respect to a first boundary line and is connected to the first machined surface along the first boundary line.

In addition, the second machined surface is a surface on which the second machined surface is located on the outside of the first machined surface with respect to the first boundary line.

The rear surface portion includes a third machined surface; and a forth machined surface which has a structure which is formed with a surface distinguished from the third machined surface with respect to a second boundary line and is connected to the third machined surface along the second boundary line.

In addition, the fourth machined surface is a surface on which the fourth machined surface is located on the outside of the third machined surface with respect to the second boundary line.

The first machined surface or the second machined surface is configured with a surface having various widths in the transverse direction, and the smallest width dimension among the various widths in the transverse direction is 0.3 to 0.8 mm.

According to the hole cutter of the present invention, it is possible to induce the smooth external discharge of cutting chips generated during the machining process, thereby preventing the problem that the cutting edge is slipped from the workpiece by being not capable of digging the workpiece or stops the rotation thereof. There is no need for the operator to remove the cutting chips individually, and the work efficiency can be increased. Specifically, it has been confirmed that the productivity can be increased by 30% or more by greatly shortening the working time compared to the hole cutter of the related art.

According to the hole cutter of the present invention, the cutting load applied to the cutting edge can be reduced, and a state where the cutting edge stably contacts the plate material can be realized so that the shaking of the cutting body can be minimized. As a result, it is possible to prevent the problem that the cutting edge is stuck in the plate material and the cutting edge is missed or broken to break the hole cutter or stop the rotation of the hole cutter, to precisely machine holes that exactly fit the standard dimensions and to secure a smooth and clean workpiece surface to be machined.

### BRIEF DESCRIPTION OF THE DRAWINGS

FIG. 1 is a perspective view illustrating a hole cutter according to the present invention.

FIG. 2 is a top view illustrating a hole cutter according to the present invention.

FIG. 3 is a perspective view illustrating a cutting edge according to the present invention.

FIG. 4 is a top view illustrating the cutting edge according to the present invention.

FIG. 5 is a sectional view illustrating a cutting edge according to the present invention.

DESCRIPTION OF REFERENCE NUMERALS

| | |
|---|---|
| 10: cutting body | 20: cutting edge |
| 20a: unit cutting edge | 21: first machined surface |
| 22: second machined surface | 23: third machined surface |
| 24: fourth machined surface | 30: body of cutting body |
| 40: drill bit | 50: drill holder |
| 51: holder body | 52: shank |
| 53: fixing surface | 60: extraction spring |
| K1: first boundary line | K2: second boundary line |
| K3: third boundary line | W1: minimum width |

### DETAILED DESCRIPTION

The terminology used herein is for the purpose of describing particular embodiments only and is not intended to be limiting of the invention. The singular representation includes plural representation unless the context clearly dictates otherwise. It should be understood that the terms “comprises”, “have”, and the like are intended to specify that there are features, numbers, steps, operations, components, parts or combination thereof which are described in the specification, but do not exclude the presence or addition of one or more other features, numbers, steps, operations, components, parts or combinations thereof, in advance.

In addition, in this specification, “on” or “above” means to be located above or below the object portion, which does not necessarily mean that the object is located on the upper side in the gravity direction. In other words, “on” or “above” as used herein, includes not only a case of locating above or below the object portion but also a case of locating before or after the object portion.

In addition, when a portion such as a region, a plate, or the like is located “on or above” the other portion, this includes not only a case of being directly in contact with the other portion or there is spacing therebetween, but also a case where there is another portion therebetween.

In addition, in this specification, it should be understood that when a component is referred to as “being coupled” or “being connected” to another component, the component may be directly coupled or directly connected to the other component, but unless an opposite description thereto is present, the component may be coupled or connected via another component therebetween.

In addition, in this specification, the terms first, second, or the like may be used to describe various components, but the components should not be limited by the terms. The terms are used only for the purpose of distinguishing one component from another.

Hereinafter, preferred embodiments, advantages, and features of the present invention will be described in detail with reference to the accompanying drawings.

For reference, the present invention can induce smooth external discharge of cutting chips generated during the hole machining process, particularly through the characteristic structure of the cutting edge 20 among the configurations of the hole cutter, it is possible to reduce the cutting load applied to the cutting edge 20 and minimize the shaking of the cutting body 10 which is generated during the hole machining process. Accordingly, particularly, the structural features of the cutting edge 20, among the various configurations of the hole cutter, will be described below.

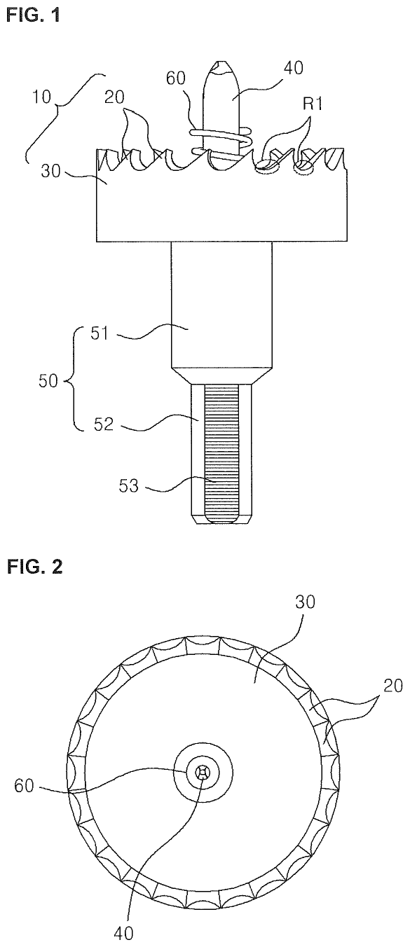

FIG. 1 is a perspective view illustrating a hole cutter according to the present invention, and FIG. 2 is a top view illustrating a hole cutter according to the present invention.

Referring to FIGS. 1 and 2, a hole cutter according to the present invention includes a drill bit 40, a cutting body 10, and a drill holder 50, and preferably can further include an extraction spring 60.

The drill bit 40 of the present invention is coupled to the drill holder 50 and is disposed on the center axis C1 of the cutting body 10 and a portion thereof is accommodated inside the cutting body 10, and another portion thereof protrudes outside the cutting body 10. Preferably, the drill bit 40 may be a twisted blade.

The drill bit 40 serves to prevent the momentary slippage of the cutting body 10 on the surface of the plate material when the plate material is cut by being pierced and inserted into the plate material just before cutting of the plate material by the cutting body 10 is started.

In addition, the drill bit 40 is located at the center point of the hole formed by the hole cutter and pierces the center point so that the cutting edge 20 comes into contact with the correct position with respect to the center point to pierce the hole having a predetermined diameter.

The cutting body 10 of the present invention includes a body 30 and a cutting edge 20.

The body 30 of the cutting body 10 is configured such that one end surface thereof is open and is shorter than the drill bit 40 so that the drill bit 40 can be protruded into the opening of the one end surface thereof.

The body 30 may have a cylindrical shape with an inner hollow space in which a portion of the drill bit 40 is accommodated. According to a preferred embodiment, the body 30 may have a cylindrical container shape whose upper surface is open and hollow inside.

Such a body 30 may be fixed to the drill holder 50 together with the drill bit 40 so that the cutting body 10 rotates together when the drill bit 40 is rotated.

The cutting edge 20 of the cutting body 10 includes a plurality of unit cutting edges 20a disposed in a serrated shape along the edge thereof in the upper region (that is, opening side) of the body 30, and the plate material is cut by the rotation of the cutting body 10 so as to machine the hole. A detailed description of the structural features of the cutting edge 20 will be given below.

The drill holder 50 of the present invention includes a holder body 51 and a shank 52.

The holder body 51 is engaged with the drill bit 40 so that the drill bit 40 can be fixed on the central axis of the cutting body 10 and a shank 52 is formed at one end portion thereof.

The holder body 51 is formed to extend on the central lower surface of the body 30 of the cutting body and is configured so that the drill bit 40 is capable of mounting on the holder body 51 through an insertion hole pierced and formed in a central portion of the body 30 of the cutting body.

The shank 52 is formed to extend on the lower end portion of the holder body 51 and is coupled to the drill chuck to function to rotate the hole cutter in conjunction with driving of the drilling machine at the time of driving of the drilling machine.

Meanwhile, at least one planar fixing surface 53 may be formed on the side surface of the shank 52. The fixing surface 53 serves to prevent the shank 52, which is coupled to the drill chuck, from being idle.

The extraction spring 60 of the present invention is installed to surround the outer circumferential surface of the drill bit 40 and serves to remove the cutting chips generated during the hole cutting process from the inside of the cutting body 10.

Specifically, the extraction spring 60 is in a state of being elastically compressed while pushed by the plate material when cutting the plate material. When the hole cutting is completed, the extraction spring 60 returns to the original state thereof by the elastic restoring force. At this time, the cutting chip having lost the bonding force from the plate material is pushed out of the cutting body 10.

Hereinafter, the characteristic structure of the cutting edge 20 according to the present invention will be described in detail.

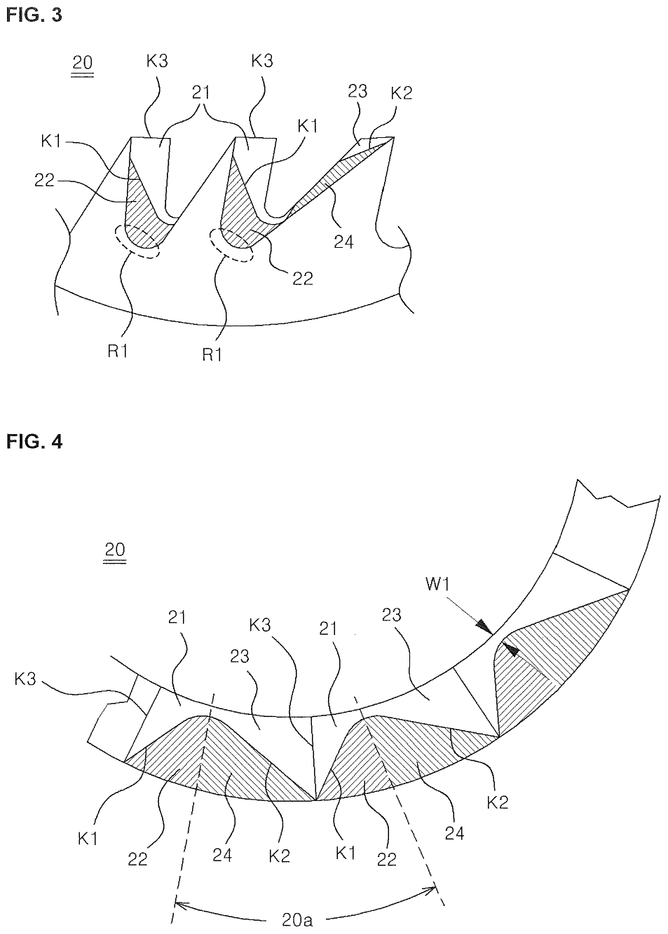

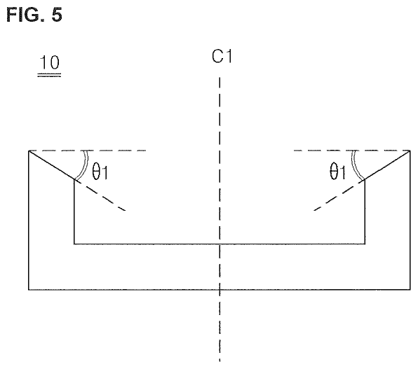

FIG. 3 is a perspective view illustrating a cutting edge according to the present invention, FIG. 4 is a top view illustrating the cutting edge according to the present invention, and FIG. 5 is a sectional view illustrating a cutting edge according to the present invention.

Referring to FIGS. 3 to 5, the cutting edge 20 of the present invention includes a plurality of unit cutting edges 20a disposed at the upper end of the body 30 along the edge of the body 30 in a serrated shape.

For reference, as used herein, the term “unit cutting edge 20a” refers to an individual blade that makes up the entire serrated cutting edge 20. Hereinafter, in order to clearly explain the structural characteristics of the unit cutting edge 20a, the specific blade portion corresponding to the unit cutting edge 20a of the present invention will be defined as follows.
Unit cutting edge 20a: referring to FIG. 4, as a cutting edge portion corresponding to the first minimum width point to the second minimum width point of the entire cutting edge 20, and a plurality of unit cutting edges 20a are arranged at regular intervals along the upper-end edge of the body 30.

Here, the ‘minimum width’ of the first and second minimum widths is a width W1 of a point at which the first machined surface 21 and the third machined surface 23 are connected to each other, and corresponds to the smallest width W1 among the various widths of the first machined surface 21 and the third machined surface 23 in the transverse direction.

In addition, the ‘minimum width point’ means a point corresponding to the minimum width W1, the first minimum width point means any one of a plurality of minimum width points and the second minimum width point means another minimum width point closest to the first minimum width point.

The unit cutting edge 20a includes a front surface portion, an inner surface portion, an outer surface portion, and a rear surface portion.

The inside surface portion of the unit cutting edge 20a refers to a surface portion facing the inside of the cutting body 10.

The outside surface portion of the unit cutting edge 20a is referred to a surface portion located on the opposite side of the inside surface portion and directed to the outside of the cutting body 10.

The front surface portion of the unit cutting edge 20a refers to a surface portion located on the front side of the unit cutting edge 20a with respect to the rotation direction of the cutting edge 20.

The front surface portion of the unit cutting edge 20a includes a first machined surface 21 and a second machined surface 22.

The first machined surface 21 of the front surface portion corresponds to one surface constituting the front surface portion and the first machined surface 21 corresponds to a surface which is distinguished from the second machined surface 22 with respect to the first boundary line K1.

The first machined surface 21 may be formed in a surface shape including a flat surface or a curved surface. The first machined surface 21 has a structure in which the first machined surface 21 is in contact with another surface starting from the first boundary line K1. In this way, the other surface contacting the first machined surface 21 corresponds to the second machined surface 22.

The first machined surface 21 is configured to have a portion where the width thereof in the transverse direction gradually increases toward the upper side of the first machined surface 21 (that is, tip K3 of unit cutting edge 20a). For example, as in the embodiment of FIGS. 3 and 4, the first machined surface 21 may be configured to have a portion where the width in the transverse direction gradually increases from the lower region to the upper region thereof.

As described above, the first machined surface 21 includes a surface having various widths in the transverse direction, and the smallest width W1 among the various widths in the transverse direction is configured to satisfy a predetermined range of dimensions.

For reference, the cutting edge 20 of the present invention is configured such that a third boundary line K3 to be described later functions as a primary machining line, the first boundary line K1 described above functions as a secondary machining line, and it is possible to induce the cutting chip to be smoothly discharged to the outside of the cutting body 10 by configuring the front surface portion of the cutting edge 20 to be a two-step machined surface (that is, first and second machined surfaces).

The inventor of the present invention has found that, in particular, the lower limit position of such a secondary machining line (that is, first boundary line K1) is related to the smooth discharge of the cutting chips, and the smooth discharge of the cutting chips, in particular, is related to the minimum width of the first machined surface 21. Here, “the lower limit position of the secondary machining line” means a position closest to the center of the cutting body 10 among the entire first boundary line K1.

Specifically, considering the smooth discharge of cutting chips, the smallest width W1 of the various widths of the first machined surface 21 in the transverse direction is formed in a range of 0.3 to 0.8 mm, preferably 0.4 to 0.6 mm.

When the minimum width W1 of the first machined surface 21 in the transverse direction is less than 0.3 mm, the cutting chip enters the inside of the cutting body 10 and is caught in the extraction spring 60, and thus the extraction spring 60 will not be able to function. When the minimum width W1 of the first machined surface 21 in the transverse direction exceeds 0.8 mm, it is possible to prevent the occurrence of the induction action of cutting chip external discharge by the two-stage machined surface (that is, first and second machined surfaces).

According to a preferred embodiment, the minimum width W1 of the first machined surface 21 in the transverse direction may be a width of a point at which the width of the unit cutting edge 20a in the transverse direction gradually becomes smaller and reaches the minimum in the unit cutting edge 20a toward the lower side thereof.

The second machined surface 22 of the front surface portion is another surface constituting the front surface portion and corresponds to a surface distinguished from the first machined surface 21 with respect to the first boundary line K1.

The second machined surface 22 may be formed in a surface shape including a flat surface or a curved surface, and preferably, may be configured with a shape in which a curved surface and a flat surface may be formed in a surface.

The second machined surface 22 is formed in a structure which is connected to the first machined surface 21 along the first boundary line K1 and thus, finally, forms a structure in which the two surfaces (that is, first and second machined surfaces) which are distinguished from each other with respect to the first boundary line K1 form the front surface portion.

A line portion which is formed by the first machined surface 21 and the second machined surface 22 are in contact with each other corresponds to the first boundary line K1.

The second machined surface 22 is configured to be a surface located further outward than the first machined surface 21 with respect to the first boundary line K1. In other words, the second machined surface 22 is formed so as to be a surface located farther from the center axis of the cutting body 10 or the inside of the body 30 than the first machined surface 21, with respect to the first boundary line K1.

The second machined surface 22 is configured to have a portion where the width in the transverse direction gradually decreases as approaching the upper side of the second machined surface 22 (that is, tip K3 of unit cutting edge 20a). For example, as in the embodiment of FIGS. 3 and 4, the second machined surface 22 may be configured to have a portion where the width in the transverse direction gradually decreases from the lower region to the upper region.

The rear surface portion of the unit cutting edge 20a refers to a surface portion located on the opposite side of the front surface portion.

The rear surface portion of the unit cutting edge 20a includes a third machined surface 23 and a fourth machined surface 24.

The third machined surface 23 of the front surface portion is a surface constituting the rear surface portion and the third machined surface 23 corresponds to the surface distinguished from the fourth machined surface 24 with respect to the second boundary line K2.

The third machined surface 23 may be formed in a form of a surface including a curved surface or a flat surface. The third machined surface 23 has a structure in which the third machined surface is in contact with another surface starting from the second boundary line K2. In this way, the other surface contacting the third machined surface 23 corresponds to the second machined surface 22.

The third machined surface 23 is configured to have a portion where the width in the transverse direction gradually increases as the upper side (that is, tip K3 of unit cutting edge 20a) of the third machined surface 23 approaches. For example, as in the embodiment of FIGS. 3 and 4, the third machined surface 23 may be configured to have a portion where the width in the transverse direction gradually increases from the lower region to the upper region.

As described above, the third machined surface 23 is configured with a surface having various widths in the transverse direction, and the smallest width W1 among the various widths in the transverse direction is configured to satisfy a predetermined range of dimensions.

For reference, the cutting edge 20 of the present invention configures the rear surface portion of the cutting edge 20 as a two-step machined surface (that is, third and fourth machined surfaces) and thus it is possible to induce the cutting chip to be smoothly discharged to the outside of the cutting body 10, together with the two-step machined surface (that is, first and second machined surfaces) of the front surface portion.

In consideration of smooth discharge of the cutting chips, the smallest width W1 of the various widths of the third machined surface 23 in the transverse direction may be formed in a range of 0.3 to 0.8 mm, preferably 0.4 to 0.6 mm.

When the minimum width W1 of the third machined surface 23 in the transverse direction is less than 0.3 mm, the cutting chip enters the inside of the cutting body 10 and is caught in the extraction spring 60, the extraction spring 60 will not be able to function. When the minimum width W1 of the first machined surface 21 in the transverse direction exceeds 0.8 mm, the cutting chip external discharge inducing action by the two-step machined surface (that is, third and fourth machined surfaces) is lost.

According to a preferred embodiment, the minimum width W1 of the third machined surface 23 in the transverse direction may be a width of the point at which the width of the unit cutting edge 20a in the transverse direction gradually becomes smaller and reaches the minimum in the unit cutting edge 20a toward the lower side thereof.

Meanwhile, the first machined surface 21 of the first unit cutting edge is configured with a shape which is connected to the third machined surface 23 of the second unit cutting edge disposed adjacent to the first unit cutting edge. Therefore, when forming the first and third machined surfaces 21 and 23, in a case where a point where the width in the transverse direction gradually becomes smaller and thus reaches the minimum toward the lower side of the corresponding machined surfaces 21 and 23 is configured to have the minimum width W1, the first unit cutting edge and the second unit cutting edge form a structure in which the first machined surface 21 and the third machined surface 23 are connected to each other with the minimum width W1 as a starting point.

The fourth machined surface 24 of the rear surface portion is another surface constituting the rear surface portion and corresponds to a surface which is distinguished from the third machined surface 23 with respect to the second boundary line K2.

The fourth machined surface 24 may be formed as a surface including a curved surface or a flat surface, and may preferably be configured as a flat surface.

The fourth machined surface 24 is formed with a structure which is connected to the third machined surface 23 along the second boundary line K2 so that the two surfaces (that is, third and fourth machined surfaces) distinguished from each other with respect to the second boundary line K2 form a rear surface portion.

The line portion where the third machined surface 23 and the fourth machined surface 24 are in contact with each other corresponds to the second boundary line K2.

The fourth machined surface 24 is configured to be a surface located further outward than the third machined surface 23 with respect to the second boundary line K2. In other words, the fourth machined surface 24 is formed so as to be a surface located farther from the central axis of the cutting body 10 or the inside of the body 30 than the third machined surface 23 with respect to the first boundary line K1.

The fourth machined surface 24 is configured to have a portion where the width in the transverse direction gradually decreases as the fourth machined surface approaches the upper side of the fourth machined surface 24 (that is, tip K3 of unit cutting edge 20a). For example, as in the embodiment of FIGS. 3 and 4, the fourth machined surface 24 may be configured to have a portion where the width in the transverse direction gradually decreases from the lower region to the upper region.

Hereinafter, the connection structure between the first, second, third, and fourth machined surfaces will be described.

The first machined surface 21 is formed to be connected to the third machined surface 23 along the third boundary line K3 and, at this time, the third boundary line K3 is configured to be the tip of the unit cutting edge 20a. In other words, the boundary line (that is, third boundary line K3) at which the first machined surface 21 and the third machined surface 23 are in contact with each other corresponds to the tip of the unit cutting edge 20a. Here, “tip K3 of unit cutting edge 20a” means a sharp blade portion that causes substantial cutting in the cutting edge 20.

The third boundary line K3 is formed so as to be inclined downward from the outside to the inside of the cutting body 10 by a predetermined gradient. In other words, the tip K3 of the unit cutting edge 20a is formed to be inclined downward in the direction of the center axis C1 of the cutting body 10, specifically, inclined downward by an angle θ1 of 1° to 5°.

When the inclination angle θ1 of the third boundary line K3 is less than 1°, since the region being initially in contact with the workpiece is widened, the cutting load reduction effect is hardly obtained. When the inclination angle θ1 of the third boundary line K3 is larger than 5° since a portion near the outer surface portion of the cutting edge 20 of the tip K3 of the unit cutting edge 20a is quickly worn, the hole cutter life is shortened.

Therefore, when the tip K3 of the unit cutting edge 20a is formed to be inclined downward at an inclination angle θ1 of 1° to 5°, the life of the hole cutter can remain almost intact, and the cutting load applied to the cutting edge 20 can be reduced during the hole machining.

In the cutting edge 20 of the present invention, the first, second, third, . . . , N unit cutting edges 20a are arranged at regular intervals, so that the first unit cutting edge is disposed adjacent to the second unit cutting edge and the second unit cutting edge is disposed adjacent to the third unit cutting edge.

The first machined surface 21 of the first unit cutting edge is configured to connect with the third machined surface 23 of the second unit cutting edge.

In this case, the portion including the region where the first machined surface 21 of the first unit cutting edge and the third machined surface 23 of the second unit cutting edge are connected to each other has a curved surface portion R1 formed in a round shape.

The second machined surface 22 of the first unit cutting edge is configured to connect to the fourth machined surface 24 of the second unit cutting edge.

In this case, the portion including the region where the second machined surface 22 of the first unit cutting edge and the fourth machined surface 24 of the second unit cutting edge are connected to each other has a curved surface portion R1 formed in a round shape.

For reference, in a case of the embodiments of FIGS. 1 and 3, the machined surface corresponding to the lower end portion of the groove formed between the first unit cutting edge and the second unit cutting edge has the rounded curved surface R1.

As described above, when the machined surface corresponding to the lower end portion of the groove formed between the first unit cutting edge and the second unit cutting edge is formed in a round curved surface, it is possible to induce the smooth external discharge of the cutting chips generated in the hole machining process.

As described above, the unit cutting edge 20a according to the present invention includes a front surface portion having two-step machined surfaces (that is, first and second machined surfaces) and a rear surface portion having another two-step machined surface (that is, third and fourth machined surfaces).

According to the two-step machined surface structure as described above, when the hole cutter is brought into contact with the plate material for hole machining, the third boundary line K3 described above acts as a primary machining line, and then the first boundary line K1 acts as a secondary machining line.

The third boundary line K3, which is the first machining line, is formed to be inclined downward to 1° to 5°, and the machined surface corresponding to the lower end portion of the groove between the unit cutting edges 20a has a rounded curved surface.

As described above, the cutting edge 20 of the present invention exhibits the following actions and effects by organically combining a plurality of structural features.

In other words, it is possible to induce smooth external discharge of cutting chips generated during the hole machining process, thereby preventing the problem that the cutting edge 20 cannot dig a workpiece and slip or stop rotation thereof, it is not necessary to remove the cutting chips during the hole machining process, and thus the working efficiency can be increased. Specifically, it has been confirmed that the productivity can be increased by 30% or more by greatly shortening the working time compared to the high-speed-steel hole cutter of the related art.

In addition, the cutting load applied to the cutting edge 20 can be reduced, and the state where the cutting edge 20 stably contacts the plate material can be realized so that the shaking of the cutting body 10 can be minimized. Accordingly, it is possible to prevent the problem that the cutting edge is stuck in the plate material and the cutting edge is missed or broken to break the hole cutter or stop the rotation of the hole cutter, to precisely machine holes that fit the standard dimensions and to secure a smooth and clean workpiece surface to be machined.

While the preferred embodiments of the present invention have been described and illustrated above using specific terms, such terms are used only for the purpose of clarifying the invention, and in the embodiments of the described terms of the present invention, it will be obvious that various changes and modifications may be made without departing from the spirit and scope of the following claims. Such modified embodiments should not be understood individually from the spirit and scope of the present invention but should be regarded as being within the scope of the claims of the present invention.

What is claimed is:

1. A hole cutter which includes a cylindrical body; and a plurality of unit cutting edges disposed along an edge of the body,
wherein the unit cutting edge includes a front surface portion, an inside surface portion, an outside surface portion, and a rear surface portion, and
wherein the front surface portion includes
a first machined surface; and
a second machined surface which has a structure which is formed with a surface distinguished from the first machined surface with respect to a first boundary line K1 and is connected to the first machined surface along the first boundary line K1.

2. The hole cutter according to claim 1,
wherein the second machined surface is a surface which is located on the outside of the first machined surface with respect to the first boundary line K1.

3. The hole cutter according to claim 2,
wherein the first machined surface is configured to have a portion in which the width in the transverse direction gradually increases toward the upper side of the first machined surface, and
wherein the second machined surface is configured to have a portion in which the width in the transverse direction gradually decreases toward the upper side of the second machined surface.

4. The hole cutter according to claim 3,
wherein the first machined surface is configured with a surface having various widths in the transverse direction, and
wherein the dimension of the smallest width W1 among the various widths in the transverse direction is 0.3 to 0.8 mm.

5. The hole cutter according to claim 1,
wherein the first machined surface and the second machined surface include a curved surface, respectively.

6. The hole cutter according to claim 1,
wherein the rear surface portion includes
a third machined surface; and
a fourth machined surface which has a structure which is formed with a surface distinguished from the third machined surface with respect to a second boundary line K2 and is connected to the third machined surface along the second boundary line K2.

7. The hole cutter according to claim 6,
wherein the fourth machined surface is a surface which is located on the outside of the third machined surface with respect to the second boundary line K2.

8. The hole cutter according to claim 7,
wherein the third machined surface is configured to have a portion in which the width in the transverse direction gradually increases toward the upper side of the third machined surface, and
wherein the fourth machined surface is configured to have a portion in which the width in the transverse direction gradually decreases toward the upper side of the second machined surface.

9. The hole cutter according to claim 8,
wherein the third machined surface is configured with surfaces having various widths in the transverse direction, and
wherein the dimension of the smallest width W1 among the various widths in the transverse direction is 0.3 to 0.8 mm.

10. The hole cutter according to claim 6,
wherein the first machined surface has a structure connecting to the third machined surface along a third boundary line K3, and
wherein the third boundary line K3 is a tip of the unit cutting edge.

11. The hole cutter according to claim 10,
wherein the third boundary line K3 is formed so as to be inclined downward from the outside to the inside of the cutting body by an angle θ1 of 1° to 5°.

12. The hole cutter according to claim 6,
wherein the plurality of unit cutting edges include a first unit cutting edge and a second unit cutting edge which are disposed adjacent to each other, and
wherein the first machined surface of the first unit cutting edge is formed in a shape connecting to the third machined surface of the second unit cutting edge.

13. The hole cutter according to claim 12,
wherein a portion including a region where the first machined surface of the first unit cutting edge and the third machined surface of the second unit cutting edge are connected to each other has a curved surface portion R1 formed in a round shape.

14. The hole cutter according to claim 6,
wherein the plurality of unit cutting edges include a first unit cutting edge and a second unit cutting edge which are disposed adjacent to each other, and
wherein the second machined surface of the first unit cutting edge is configured to be connected to the fourth machined surface of the second unit cutting edge.

15. The hole cutter according to claim 14,
wherein a portion including a region where the second machined surface of the first unit cutting edge and the fourth machined surface of the second unit cutting edge are connected to each other has a curved surface portion formed in a round shape.

16. The hole cutter according to claim 7,
wherein the first machined surface has a structure that is connected to the third machined surface along a third boundary line K3, and
wherein the third boundary line K3 is a tip of the unit cutting edge.

17. The hole cutter according to claim 16,
wherein the third boundary line K3 is formed so as to be inclined downward from the outside to the inside of the cutting body by an angle θ1 of 1° to 5°.
